(19) United States
(12) Patent Application Publication
(10) Pub. No.: US 2009/0257610 A1
(43) Pub. Date: Oct. 15, 2009

(54) Quasi-permanent battery for hearing aids

(75) Inventors: Fan Wu, Scottsdale, AZ (US); Samuel L. Thomasson, Gilbert, AZ (US)

Correspondence Address: Paul F. Wille, 6407 East Clinton St., Scottsdale, AZ, 85254, US

(73) Assignee: Zounds, Inc., Mesa, AZ (US)

(21) Appl. No.: 12/082,164

(22) Filed: Apr. 9, 2008

(51) Int. Cl. H04R 25/00

(52) U.S. Cl. 381/323

(57) ABSTRACT

A hearing aid includes a secondary battery and means for identifying the kind of battery for charging. After the battery is identified, an appropriate algorithm for charging the battery is selected and used for charging the battery. Primary batteries are not charged. The hearing aid also includes a voltage reduction circuit for supplying a constant voltage to circuitry within the hearing aid. The battery preferably has an energy density greater than 500 watt-hours per liter.

This invention relates to hearing aids and, in particular, to a hearing aid powered by a substantially non-replaceable battery.

### BACKGROUND TO THE INVENTION

As used herein, a “primary” battery is one that is not intended for charging even though, in fact, one can safely recharge the battery one or a few times. A “secondary” battery is one that is intended for recharging a plurality of times. In general, primary batteries have a greater capacity (store more energy) than rechargeable batteries. Secondary batteries have a different internal structure from primary batteries, even when the chemistry involved is nominally the same.

Hearing aids powered by a battery have been known for almost a century; see U.S. Pat. No. 1,219,411 (Williams), for example. Modern technology has increased battery life greatly, yet it is annoying to have to replace batteries. Rechargeable batteries are a partial solution but require removal of the hearing aid and placement in a charger. Unless a user has two sets of hearing aids, the charging can be inconvenient.

Hearing aids having rechargeable batteries have been known in the art for a long time; e.g., see U.S. Pat. No. 3,297,933 (McCarthy). The trade-off between rechargeable batteries and non-rechargeable batteries is the inconvenience of having to replace the battery. There is also a trade-off in capacity. A non-rechargeable battery lasts much longer than a rechargeable battery having the same outside dimensions as the non-rechargeable battery. The similarity in shape and dimensions can and does cause confusion among users. The industry has adopted color codes on packaging to distinguish batteries but the problem persists.

Substituting a secondary battery for a primary battery is not as dangerous as substituting a primary battery for a secondary battery. Secondary batteries have specific charging requirements. If the requirements are not met, damage to the battery is likely and catastrophic damage is possible. Carefully charging a primary battery in a laboratory is relatively safe. Accidentally charging a primary battery substituted for a secondary battery is a very different situation and much more serious. Catastrophic failure is likely.

The need to replace batteries means that one must open a hearing aid. Moisture, wax, dirt, oils and so on, can work their way into a hearing aid, causing problems. Hearing aids can be made relatively impervious to ambient conditions. A hearing aid that is relatively impervious is also likely to be relatively difficult to open for a user.

The inconvenience of having to remove the battery from a hearing aid initially applied both to rechargeable batteries and non-rechargeable batteries. The sole advantage of rechargeable batteries was not having to be replaced. Then, chargers were developed that made electrical contact with the hearing aid, obviating the need to remove the rechargeable battery; e.g. see U.S. Pat. No. 3,493,695 (Stork). This simplified matters for those lacking the dexterity to remove and insert a battery. Having exposed electrical contacts is undesirable and inductive chargers solved this problem; e.g. see U.S. Pat. No. 4,379,988 (Mattatall).

Inductive chargers have their own set of difficulties, including adequate coupling between the primary inductor in the charger and the secondary inductor in the hearing aid; e.g. see U.S. Pat. No. 6,658,124 (Meadows). Even with adequate coupling, rechargeable batteries are not a panacea. Many rechargeable batteries, e.g. nickel cadmium, lithium ion, and others, have “memory.” Memory in a battery relates to the amount of stored energy that is available after several discharge-charge cycles. If, for example, half the energy is used and a battery is recharged, then, eventually, only half the energy is available. Also, some rechargeable batteries do not like being overcharged, such as lithium ion batteries. These batteries overheat and rupture, sometimes violently, or catch fire. Currently, nickel-metal-hydride (NiMH) batteries are preferred for hearing aids because they have little memory and are more tolerant of overcharging.

The problems of memory and overcharging are particularly acute for hearing aids because a hearing aid may partially discharge a battery during the day and then be placed on a charger overnight. If more than one hearing aid is used, the batteries may be in different states of charge but are charged simultaneously.

It is known in the art to provide a reduced voltage for operating a hearing aid; e.g. see the Williams patent cited above and U.S. Pat. No. 7,315,626 (Pedersen). The Williams patent also discloses sealing the terminals of the battery in a hearing aid. It is known in the art to provide a regulated supply voltage for the audio processing stages of a hearing aid; e.g. see U.S. Pat. Nos. 5,332,928 (Johnson), 6,741,715 (Andersen), 6,831,988 (Vonlanthen), and published application US2005/0234572 (Heubi et al.). It is also known in the art to store in memory a variable in a software program for control of battery recharging; e.g. see U.S. Pat. No. 6,565,603 (Leysieffer, et al.).

In view of the foregoing, it is therefore an object of the invention to provide a hearing aid that distinguishes a primary battery from a secondary battery and charges only a secondary battery.

Another object of the invention is to provide a hearing aid that recognizes secondary batteries and selects the charging sequence (algorithm) appropriate for the battery.

A further object of the invention is to provide a hearing aid that uses a reduced operating voltage for a reference voltage.

### SUMMARY OF THE INVENTION

The foregoing objects are achieved by this invention in which a hearing aid includes a secondary battery and means for identifying the kind of battery for charging. After the battery is identified, an appropriate algorithm for charging the battery is selected and used for charging the battery. Primary batteries are not charged. The hearing aid also includes a voltage reduction circuit for supplying a constant voltage to circuitry within the hearing aid. The battery preferably has an energy density greater than 500 Wh/l.

### BRIEF DESCRIPTION OF THE DRAWINGS

A more complete understanding of the invention can be obtained by considering the following detailed description in conjunction with the accompanying drawings, in which:

FIG. 1 illustrates a behind-the-ear (BTE) hearing aid constructed in accordance with a preferred embodiment of the invention;

FIG. 2 illustrates an alternative embodiment of the invention;

FIG. 3 illustrates a “button” style battery typically used in hearing aids;

FIG. 4 is a chart of the charge-discharge characteristics of a silver-zinc rechargeable battery;

FIG. 5 is a chart of the charge-discharge characteristics of a nickel-metal-hydride rechargeable battery;

FIG. 6 is a detail from FIG. 5;

FIG. 7 is a schematic of a portion of the electronics in a hearing aid constructed in accordance with a preferred embodiment of the invention; and

FIG. 8 is a charging unit constructed in accordance with a preferred embodiment of the invention.

### DETAILED DESCRIPTION OF THE INVENTION

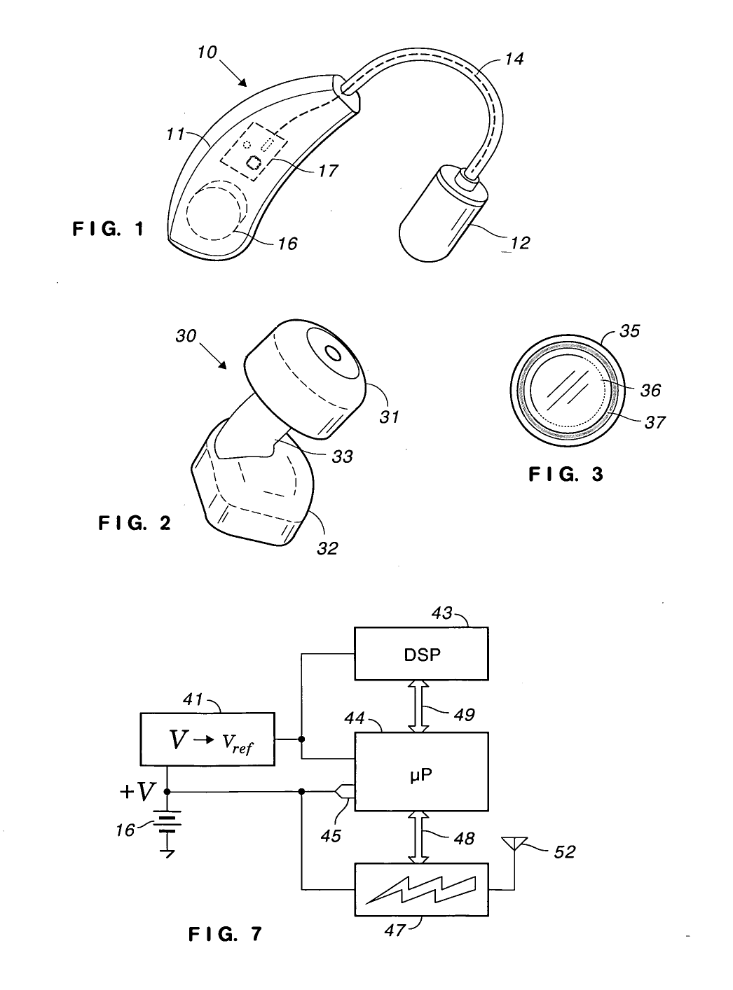

In FIG. 1, hearing aid 10 includes body 11 coupled to earpiece 12 by cable 14. Within body 11 are battery 16 and circuit board 17. Circuit board 17 includes the circuitry for processing audio signals to provide hearing correction voltage regulation, and charging circuitry. A speaker (not shown) is located in earpiece 12 and a microphone (not shown) is located in body 11. The speaker is coupled to circuit board 17 by electrical cable 14.

FIG. 2 illustrates an alternative embodiment of the invention in which a speaker (not shown) is located in earpiece 31, which fits in the ear canal of a user. Earpiece 31 is coupled to body 32 by neck 33. Body 32 fits in the outer ear or auricle of a user. A battery (not shown) and electronics are located in body 32.

Battery 16 (FIG. 1) is located in a suitable socket that receives a battery having a type P13 case. In a preferred embodiment of the invention, battery 16 is a silver-zinc (AgZn) secondary battery from Zpower in Camarillo, Calif. This battery has a nominal voltage of 2.1 volts and higher (≈30%) energy density than other secondary batteries. Any secondary AgZn battery with an energy density greater than 500 watt-hours per liter (Wh/l) is preferred. This allows longer time between charges or a smaller battery for the same time between charges as other batteries of a given size. (For the sake of comparison, a typical primary AgZn battery has an energy density slightly less than 1500 Wh/l.)

FIG. 3 is a plan view of a P13 type case. The battery looks like a small button and has an outer, conductive case 35 that is the negative terminal and a central contact 36 that is the positive terminal. Insulator 37 separates the terminals. Outer case 35 has a diameter of approximately 7.9 mm and the battery is approximately 5.4 mm thick. The particular type of case is not the invention, i.e. it is not the solution. It is the problem. There are several styles or types of cases that contain electrically different batteries. FIG. 3 illustrates one of them.

In both of the following examples, a fully discharged battery is presumed at the start of the charging cycle. Charging follows the manufacturer's recommended procedure. Discharge is the maximum rated current.

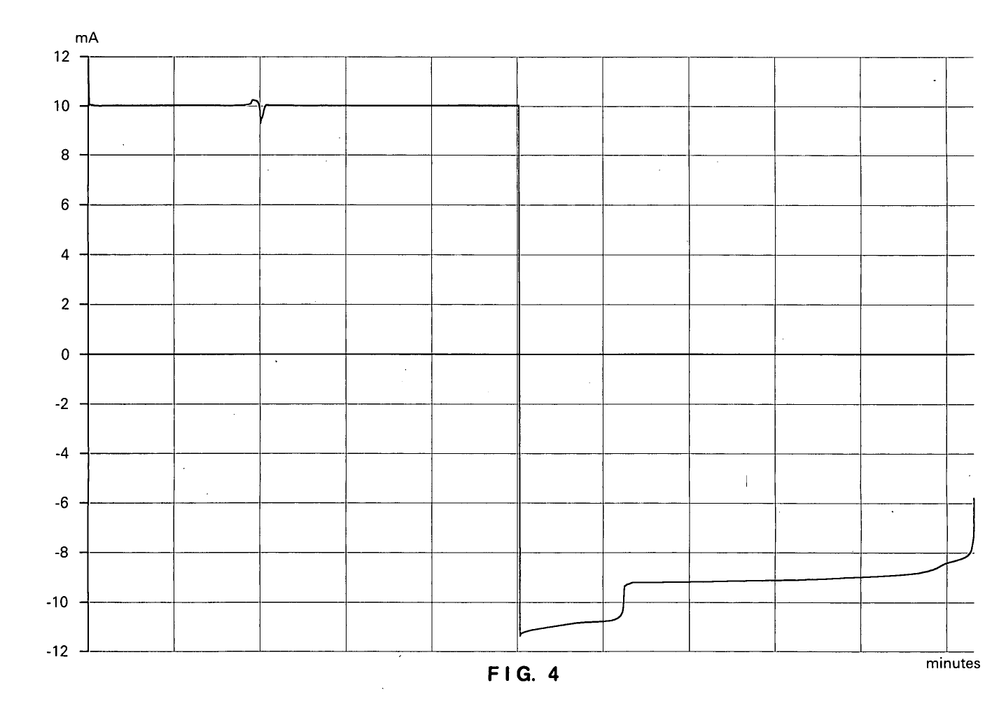

There are several different batteries that can fit a socket for battery 16. FIG. 4 is a chart of the charge-discharge curve for a silver-zinc battery. Positive current is charging current and negative current is discharging current. Charging is essentially at a constant current until a predetermined voltage is reached, upon which charging is terminated. For the preferred battery, the predetermined voltage is 2.1 volts.

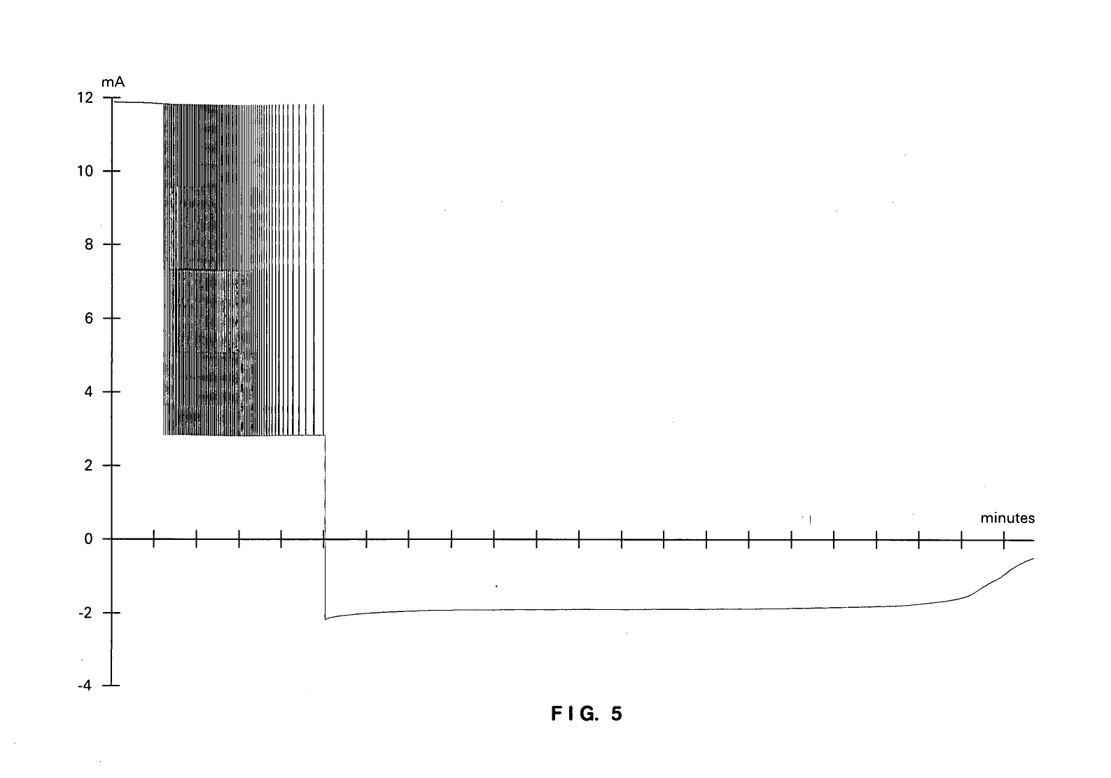

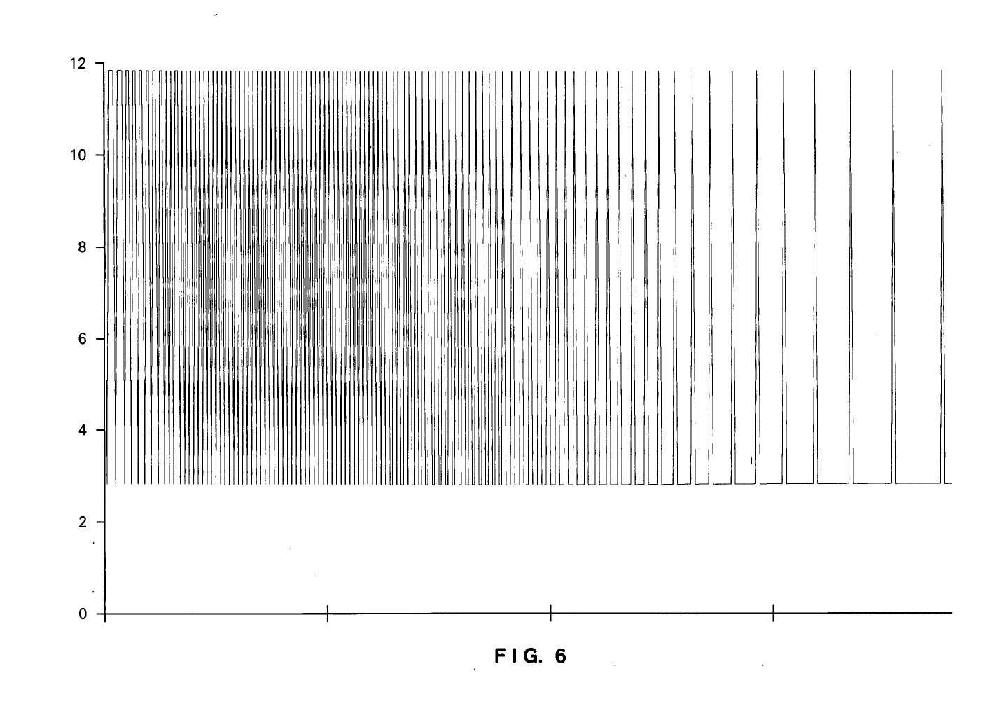

FIG. 5 is a chart of the charge-discharge curve for a nickel-metal hydride (NiMH) battery. Positive current is charging current and negative current is discharging current. The charging cycle has two distinct phases. The first phase is a steady, although not constant, current of approximately 12 ma. that lasts approximately two hours. The charging then changes drastically to a pulsed charging cycle in which the current varies between 12 ma. and 3 ma., approximately. The duty cycle of the pulses decreases from approximately fifty percent to less than five percent over a period of approximately six hours.

Although the charging patterns for a silver-zinc battery and NiMH battery are obviously quite different, the discharge patterns are significantly different also. The silver-zinc battery charges for approximately eight hours and can be discharged in approximately eight and one half hours. The NiMH battery charges for a total of about eight hours and discharges in approximately twenty-seven and one half hours. More significant is the discharge rate. The silver-zinc battery charges at approximately ten ma. and discharges at approximately nine ma., after a brief period discharging at eleven ma. The NiMH battery discharges at only two ma. Thus, significantly more current can be drawn, if need be, from a silver-zinc battery and the battery can discharged at substantially the same current as used for charging.

In accordance with one aspect of the invention, the type of battery inserted into hearing aid 10 (FIG. 1) is recognized by the electronics on circuit board 17. FIG. 7 illustrates some of the circuitry in more detail.

In FIG. 7, battery 16 is coupled to voltage reducing circuit 41. In its simplest form, voltage reducing circuit could be a resistor, as disclosed in the Williams patent cited above. In accordance with the invention, voltage reducing circuit includes active devices for converting 2.1 volts to 1.2 volts and providing a constant voltage output. This voltage is used as both an operating voltage and a reference voltage for digital signal processing (DSP) circuit 43 and microprocessor 44. For DSP circuit 43, a constant supply voltage enables more precise operation in processing audio signals. For microprocessor 44, a constant supply voltage simplifies analog to digital (A/D) conversion and makes the conversion more accurate.

As illustrated in FIG. 7, the positive terminal of battery 16 is coupled to an A/D input of microprocessor 44. Recharging circuit 47 is coupled to microprocessor 44 by data base 48. Data base 48 includes address, control, and data lines, either separately or multiplexed. Microprocessor 44 communicates with DSP circuit 43 over data base 49, which can be separate from or a continuation of data base 48.

By applying selected currents and loads to battery 16, microprocessor 44 can identify what kind of battery it is. At a minimum, AgZn is distinguished from NiMH. The proper charging algorithm is then selected and battery 16 is charged when necessary. For example, the following procedure is used.
monitor battery voltage.
apply 10 ma. of charging current for five minutes.
if battery voltage is >1.6V,
then switch to AgZn charging procedure,
else use NiMH charging procedure.

For detecting primary batteries, the decision tree becomes more complicated but is based, as above, on the characteristics of the batteries. For example, a discharged NiMH battery will increase in voltage only slightly after being charged for a minute or two but a discharged AgZn primary battery will increase in voltage very quickly. On the other hand, the voltage will not exceed 1.55 volts for a AgZn primary battery. Thus, one can readily distinguish a primary AgZn battery from a NiMH battery. When a primary battery is detected, the charging procedure terminates.

In one embodiment of the invention, power for charging is derived from signals received by antenna 52, as disclose in co-pending application Ser. No. ______, filed Feb. 25, 2008, and entitled RF Power Supply for Hearing Aids, the entire contents of which are hereby incorporated by reference. In alternative embodiments of the invention, inductive charging or direct electrical connection can be used.

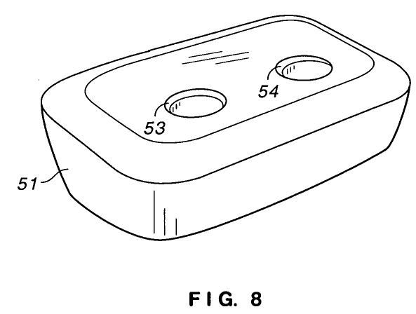

FIG. 8 illustrates a suitable charging station for either inductive or direct electrical connection. Microprocessor 44 and recharging circuit 47 are located in station 51, which is powered by larger batteries, such as D-cells, or from a power line. A hearing aid inserted into one of receptacles 53 and 54 is identified and charged correctly, or not charged at all if a primary battery is detected. As known in the art, the state of charge can be detected for a known type of battery and a partially discharged battery can be fully charged without overcharging.

The invention thus enables one to manufacture hearing aids that are sealed but which can be properly charged by identifying the battery within the sealed case. If fully discharged each time, a silver-zinc battery can be recharged approximately two hundred times. If less than fully discharged, a silver zinc battery can be recharged more than four hundred times and battery life starts approaching the useful life of a hearing aid. If, for some reason, there is a failure of a battery, the seal can be broken and the battery replaced. If the wrong type of battery is used, the type is detected and the battery can be charged properly despite the error. If a primary battery is installed, no charging takes place and a suitable indicator informs the user of the error.

Having thus described the invention, it will be apparent to those of skill in the art that various modifications can be made within the scope of the invention. For example, the invention is applicable to hearing aids other than the types illustrated in FIGS. 1 and 2. The invention can be incorporated into hearing aids themselves or into a charger for hearing aids. Although many microprocessors have A/D conversion included in the same semiconductor chip, separate A/D conversion circuitry can be used instead. Rather than insert a hearing aid into receptacle 53 or receptacle 54, at least one receptacle can be configured as a socket for receiving only a battery, e.g. a resilient wiper for contacting the edge (negative terminal) of a battery and a movable clip for contacting the positive terminal of the battery. A problem with a charger for batteries is the almost inevitable possibility that a battery will be inserted in the wrong polarity. Although polarity is easily detected, a user may not notice immediately and become upset when the battery is not charged as expected. It is preferred that a battery be charged while in the hearing aid.

What is claimed as the invention is:

1. A hearing aid including electronics for processing audio signals and a battery for powering said electronics characterized in that:
said battery is a silver-zinc secondary battery having an energy density greater than 500 Wh/l.

2. The hearing aid as set forth in claim 1 and further including:
a voltage reduction circuit producing a constant voltage output;
wherein said constant voltage is the supply voltage for said electronics.

3. The hearing aid as set forth in claim 1 and further including:
a microprocessor having an A/D conversion input coupled to said battery; and
a recharging circuit coupled to said microprocessor;
wherein said microprocessor is programmed to identify said battery and select the appropriate algorithm for charging said battery.

4. The hearing aid as set forth in claim 3 wherein said microprocessor is programmed not to recharge primary batteries.

5. The hearing aid as set forth in claim 4 and further including:
a voltage reduction circuit producing a constant voltage output;
wherein said constant voltage is the supply voltage for said electronics and said microprocessor.

6. A hearing aid including electronics for processing audio signals and a battery for powering said electronics characterized in that said hearing aid includes:
a microprocessor having an A/D conversion input coupled to said battery; and
a recharging circuit coupled to said microprocessor;
wherein said microprocessor is programmed to identify said battery and select the appropriate algorithm for charging said battery.

7. The hearing aid as set forth in claim 6 wherein said microprocessor is programmed not to recharge primary batteries.

8. The hearing aid as set forth in claim 6 and further including:
a voltage reduction circuit producing a constant voltage output;
wherein said constant voltage is the supply voltage for said electronics and said microprocessor.

9. The hearing aid as set forth in claim 6 wherein said battery is a secondary battery having an energy density greater than 500 Wh/l.

10. A circuit for charging the battery for a hearing aid, said circuit comprising:
means for coupling the circuit to the battery;
a microprocessor having an A/D conversion input coupled to said battery; and
a recharging circuit coupled to said microprocessor;
wherein said microprocessor is programmed to identify said battery and select the appropriate algorithm for charging said battery.

11. The circuit as set forth in claim 10 wherein said microprocessor is programmed not to recharge primary batteries.

12. The circuit as set forth in claim 10 wherein said means couples the circuit to the battery while the battery is in the hearing aid.

13. The circuit as set forth in claim 10 wherein said circuit is included in a hearing aid.

14. The circuit as set forth in claim 10 wherein said circuit is included in a charging station.
